(19) United States
(12) Patent Application Publication
(10) Pub. No.: US 2009/0283512 A1
(43) Pub. Date: Nov. 19, 2009

(54) Thermal Device

(75) Inventors: Rudiger Huhn, Lubeck (DE); Arne Schafrinski, Bad Oldesloe (DE); Florian Durr, Hamburg (DE); Martin Stranzinger, Hamburg (DE); Andreas Schirr, Bad Oldesloe (DE); Henner Tasch, Hamburg (DE); Markus Lapczyna, Kaltenkirchen (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Eppendorf AG, Hamburg (DE)

(21) Appl. No.: 12/371,062

(22) Filed: Feb. 13, 2009

Related U.S. Application Data
(60) Provisional application No. 61/029,107, filed on Feb. 15, 2008.

(51) Int. Cl. H05B 3/06; H05B 3/84

(52) U.S. Cl. 219/522; 219/526

(57) ABSTRACT

A device for heating of covers of reaction vessels including a directly and/or indirectly heated plate having an upper side which is designed with at least one or without a recessed portion, and a lower side, wherein the heated plate has at least one portion, which is translucent in the optical spectral region, at least one transparent element selected from the group of foils, plates and cuboids for covering portion of the heated plate which is translucent in the optical spectral region, wherein the at least one transparent element does not overlie the recessed portion of the heated plate; and a means for thermal insulating, wherein said means has at least one region, which is translucent in the optical spectral region and which encloses/covers the components defined.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The invention relates to a device for the heating of covers of reaction vessels as well as the use thereof in different laboratory equipments, and a method for the heating of covers of laboratory equipments.

Progress in the biomolecular research and diagnostics require improved laboratory equipments. Molecular biology and diagnostics are not imaginable without the polymerase chain reaction (PCR) (Saiki et al. (1985) Science: 230: 1350-1354). Thereby, in a sequential succession of different temperature-dependent reaction steps (denaturation of the double-strand nucleic acid, addition of primers on a denatured strand of nucleic acid, enzyme-controlled extension of the primer and re-synthesis of a nucleic acid strand along the denatured strand of nucleic acid), the nucleic acid molecules being present in a reaction mixture are amplified.

Laboratory equipments—thermocyclers—, with which the PCR reactions are performed, exist in various types. A typical thermocycler comprises at least a controlled temperature block having recesses in which reaction vessels may be inserted. Thereby, the reaction vessels are with their bottom area and portions of their walls within the recesses, however, the vessels still protrude from the recesses. Typically, the aqueous reaction mixtures do not fill the total volume of the vessel so that the upper portion of the vessel is filled with air. Now, if the aqueous reaction mixture is heated in the course of a PCR reaction to temperatures, which are typically between 55° C. and 105° C., condensation at the upper walls and regions of the cover of the reaction vessels occurs. This is disadvantageous for the PCR reaction as such, the yield of amplified molecules of nucleic acid is decreased. Different solutions for this problem are known from the prior art. So, at first, the aqueous reaction mixture was superposed with mineral oil or paraffin wax in order to prevent condensation (Sambrook J, Fritsch E F, Maniatis T (1989) Molecular cloning: A laboratory manual, 2^{nd} edition, CSHL press, Cold Spring Harbor, N.Y.).

Technical solutions to this problem regarding the equipment are known from U.S. Pat. No. 6,337,435; U.S. Pat. No. 5,552,580; U.S. Pat. No. 5,496,517. These documents describe thermocyclers having devices for heating the covers of the reaction vessels, respectively. These devices for heating each comprise a heated metallic plate, which overlies the covers of the reaction vessels, and in this manner heat the covers up to 105° C. and so prevent the formation of condensation there. Simultaneously, by means of this heated metallic plate, pressure is exerted on the covers of the reaction vessels, so that the reaction vessels are pressed into the temperature block of the thermocycler. A particular embodiment of the PCR is the real-time PCR (U.S. Pat. No. 6,171,785). Thereby, simultaneous to the sequence of the amplification reaction, the quantity of the respectively present nucleic acid molecules is determined. The determination is carried out by means of optical signals by using fluorescent dyes within the reaction mixture. Real-time thermocyclers (EP 1 256 631) have as additional components an optical detection system, which typically is arranged above the temperature block, which receives the reaction vessels. In U.S. Pat. No. 5,928,907, for the first time, a real-time thermocycler is described having a device for the heating of the covers of the reaction vessels. It solely consists of a heated metallic plate which has openings. Above the heated metallic plate are the optical elements (lenses, fibre optic, etc.) for the excitation and detection. The openings in the heated metallic plate are arranged in a manner that the covers of the reaction vessels, which are within the temperature block, are arranged under the openings of the heated plate. Thus, it is possible that through the openings of the heated metallic plate and the transparent covers of the reaction vessels, the excitation radiation can be irradiated from above into the reaction mixtures to which fluorescent dye has been added, and a fluorescent signal resulting out of it can be recorded from the optical detection system, which is arranged above. Improved embodiments for devices for the heating of real-time thermocyclers are described in U.S. Pat. No. 6,337,435, EP 1 539 353 and US 2008/0000892. U.S. Pat. No. 6,337,435 discloses a device for the heating having the following elements: a metallic plate having holes, which flatly overlies the covers of the reaction vessels, which are inside the temperature block, a heated glass plate, which directly overlies the metallic plate, a pair of lenses and above those a transparent window, which is supported by a frame. The transparent window prevents the upward escape of heat. From EP 1 539 353, a heated arrangement of plates is known, which has the following features: a heating plate having a multitude of optical openings, wherein a part of the heated plate defines a recessed portion through which a transparent cover is surrounded and supported. US 2008/0000892 discloses a device for heating, which has a heated transparent window made from crystalline sapphire, wherein the transparent window is heated. Below the sapphire window further components can be present, which facilitate the heat transfer to the covers of the reaction vessels. The predominant part of the known heating devices is not specifically thermally isolated vis-à-vis its environment. When mounting these devices into laboratory equipments, thus, also other parts can be heated what is not desired. This affects the lifetime of the laboratory equipment and furthermore is a source of danger. Therefore, there is a need for an improved device for the heating of covers of laboratory equipments, which, on the one hand, can quickly and homogeneously heat the covers of reaction vessels to the desired temperature, and, on the other hand, can also be reliably thermally isolated vis-à-vis the surroundings.

### BRIEF SUMMARY OF THE INVENTION

The invention relates to an improved device for the heating of covers of reaction vessels. The already known devices for the heating of covers of reaction vessels have no components, which specifically thermally isolate the directly and indirectly heated elements of the device.

It is surprising that in the device according to the invention, which has a means for the thermal insulation of the remaining components of the device, the lifetime of other elements in laboratory equipments, which are nearby thereof, is increased after mounting the device for heating into the laboratory equipment.

Thus, the subject-matter of the present invention is

(1) a device for heating of covers of reaction vessels, which comprises the following components:
(a) a directly and/or indirectly heated plate having an upper side which is designed with at least one or without a recessed portion, and a lower side, wherein the heated plate has at least one portion, which is translucent in the optical spectral region,
(b) at least one transparent element selected from the group of foils, plates and cuboids for covering portion (2) of the heated plate (1) which is translucent in the optical spectral region, wherein the at least one transparent element does not overlie the recessed portion of the heated plate; and
(c) a means for thermal insulating, wherein said means has at least one region, which is translucent in the optical spectral region and which encloses/covers the components defined in (a) and (b);

(2) the use of the device according to one of claims (1) in a laboratory equipment; and

(3) a method for the heating of covers in reaction vessels by using the device according to (1).

### BRIEF DESCRIPTION OF THE SEVERAL VIEWS OF THE DRAWINGS

FIG. 1: Top view of the device according to the invention. Visible is the means (or member) for thermal insulation (5) with 96 regions (9) translucent in the optical spectral region. In this embodiment said 96 regions translucent in the optical spectral region are openings passing through the entire bottom plate (5a) of the means for thermal insulation (5). Also visible are fastening means (12), e.g. screws, with which the means for thermal insulation (5) is fastened to the heated plate (not seen in the top view). Four further holes (13) are visible in the means for insulation, with which the device according to the invention can be fastened to the optical elements (not shown here) which are arranged in a conventional use above the device according to the invention. Also seen is part of the heating element (10) which in this embodiment is a resistive foil.

FIG. 2: Free view of a first embodiment of the device of according to the invention. The device is shown cut open in order to illustrate all components of said device. Said first embodiment is characterized through is heated plate with a recessed portion (14) which is filled with a thermal conductor (7). The device is shown arranged on top of a microtiter plate (15), as it would occur during conventional use of the device according to the invention, for example when the device is part of a real-time thermocycler. The heated plate (1) is with its lower side (1b) in direct contact with the microtiter plate (15). The heated plate is formed with a recessed portion (14), in which the there are 96 regions (2) which are translucent in the optical spectral region. In the present embodiment said 96 regions are formed as openings (2) which pass through the entire thickness of the heated plate (1). The heated plate (1) has a border, also called bar (6). A heating element (10), which in the present embodiment is a resistive foil with holes, is glued to the upper side of the heated plate (1a), in particular to the recessed portion (14) in such a way, that it does not cover or block the openings (2) of the heated plate (1). A thermal conductor (7) is inserted into the recessed portion (14) of the heated plate, thus filling the cavity formed between upper side of the heated plate (1) and transparent element (4). The thermal conductor (7) also a multitude of optical, radiation permeable openings (16) aligned with the at least one region translucent in the optical spectral region (2) of the heated plate. In the present embodiment the transparent element (4) is a glass plate which rests on the border, respectively bar (6) of the heated plate (1) as well as the thermal conductor (7). In the present embodiment the transparent element is glued to the border, respectively bar (6) of the heated plate. Topmost of the device is the means for thermal insulation (5) which encloses all inner components of the device according to the invention. The means for thermal insulation (5) is formed as a solid frame comprising a bottom plate (5a) from which four walls draw downwards (5b, c, d, e). The four walls are slightly thinner (ca. 1-2 mm) than the bottom plate (2-4 mm) The four walls (5-b-e) are designed to have at least a length reaching down to the cover of the vessels, in the present embodiment to the covers of the microtiter plate. Thus the means for thermal insulation (5) encloses and covers the entire assembly of all inner components of the device according to the invention, and if desired also part or the entirety of the vessels below the device according to the invention. The bottom plate (5a) comprises a multitude of optical, radiation-permeable openings (9), of which there are in the present embodiment 96. The means for thermal insulation (5) does not touch the transparent element (4), but there is an air cushion between those the components. Thus the means for thermal insulation (5) is not fastened to the transparent element (4), instead it is fastened with screws (12) to the heated plate.

FIG. 3: Shown is a full section view of a first embodiment (see also FIG. 2) of the device according to the invention. The right side of present figure is boxed and enlarged details are shown in FIG. 4. Not explicitly shown in the present figure are any vessels below the heated plate (1). The solid parts of the heated plate (1) are shown shaded, and the openings (2) are non-shaded. The glass plate (4) is shown hatched. The air cushion (11) between means for thermal insulation (5) and glass plate is indicated with a thicker black line on top of the glass plate (4).

FIG. 4: Shown is a detailed view of the boxed area of FIG. 3. Visible are the heated plate (1) with lower (1b) and upper side (1a), comprising holes (2) passing through the entire thickness of the heated plate, the heating element (10) indicated by a thick black line on top of the upper side of the heated plate (1a). On top of the heating element, lying in the recessed portion (14) of the heated plate (1) is the thermal conductor (7). The glass plate (4) can be seen as resting on the border, respectively bar (6) of the heated plate as well as the thermal conductor (7). The air cushion (11) is drawn as a thick black line on top of the glass plate (4). Topmost is the means for insulation (5) with its openings (9). All openings (2, 16, 9) passing through the entire device form together a shouldered hole.

FIG. 5: Free view of a second embodiment of the device of according to the invention. The device is shown cut open in order to illustrate all components of said device. Said second embodiment is characterized through is heated plate with a recessed portion (14) which is left unfilled. Thus an air cushion (17) forms in the cavity between recessed portion (14) of the heated plate (1) and transparent element (4). The device is shown arranged on top of a microtiter plate (15), as it would occur during conventional use of the device according to the invention, for example when the device is part of a real-time thermocycler. The heated plate (1) is with its lower side (1b) in direct contact with the microtiter plate (15). The heated plate is formed with a recessed portion (14), in which the there are 96 regions (2) which are translucent in the optical spectral region. In the present embodiment said 96 regions are formed as openings (2) which pass through the entire thickness of the heated plate (1). The heated plate (1) has a border, also called bar (6). In the present embodiment a side wall (3) draws down from the border (6) in order to enclose and surround the frame of the microtiter plate (15). The border, bar respectively (6) is characterized through its extension over the recessed portion (14). Thus a little edge forms, which stabilizes the air cushion (17) in the cavity between recessed portion (14) of the heated plate (1) and transparent element (4) A heating element (10), which in the present embodiment is a resistive foil with holes, is glued to the upper side of the heated plate (1a), in particular to the recessed portion (14) in such a way, that it does not cover or block the openings (2) of the heated plate (1). In the present embodiment the transparent element (4) is a glass plate which rests on the border, respectively bar (6) of the heated plate (1). In the present embodiment the transparent element is glued to the border, respectively bar (6) of the heated plate. Topmost of the device is the means for thermal insulation (5) which encloses all inner components of the device according to the invention. The means for thermal insulation (5) is formed as a solid frame comprising a bottom plate (5a) from which four walls draw downwards (5b, c, d, e)). The four walls are slightly thinner (ca. 1-2 mm) than the bottom plate (2-4 mm). The four walls (5-b-e) are designed to have at least a length reaching down to the cover of the vessels, in the present embodiment to the covers of the microtiter plate. Thus the means for thermal insulation (5) encloses and covers the entire assembly of all inner components of the device according to the invention, and if desired also part or the entirety of the vessels below the device according to the invention. The bottom plate (5a) comprises a multitude of optical, radiation-permeable openings (9), of which there are in the present embodiment 96. The means for thermal insulation (5) does not touch the transparent element (4), but there is an air cushion between those the components. Thus the means for thermal insulation (5) is not fastened to the transparent element (4), instead it is fastened with screws (12) to the heated plate.

FIG. 6: Shown is a full section view of a second embodiment (see also FIG. 5) of the device according to the invention, i.e. the embodiment with an air cushion (17) filling the cavity of the recessed portion (14) of the heated plate (1). The right side of present figure is boxed and enlarged details are shown in FIG. 7. Not explicitly shown in the present figure are any vessels below the heated plate (1). The solid parts of the heated plate (1) are shown shaded, and the openings (2) are non-shaded. The glass plate (4) is shown hatched. The air cushion (11) between means for thermal insulation (5) and glass can be seen.

FIG. 7: Shown is a detailed view of the boxed area of FIG. 6. Visible are the heated plate (1) with lower (1b) and upper side (1a), comprising holes (2) passing through the entire thickness of the heated plate, the heating element (10) indicated by a thick black line on top of the upper side of the heated plate (1a). An air cushion (17) forms in the cavity between recessed portion (14) of the heated plate (1) and transparent element (4). The glass plate (4) can be seen as resting on the border, respectively bar (6) of the heated plate. The air cushion (11) between the means for thermal insulation (5) and transparent element (4) can be seen. Topmost is the means for insulation (5) with its openings (9). All openings (2, 16, 9) passing through the entire device form together a shouldered hole.

FIG. 8: Free view of a third embodiment of the device of according to the invention. The device is shown cut open in order to illustrate all components of said device. Said third embodiment is characterized through is heated plate with a recessed portion (14) which is left unfilled and a border (6) of the heated plate from which a wall (3) draws down. Thus an air cushion (17) forms in the cavity between recessed portion (14) of the heated plate (1) and transparent element (4). The device is shown arranged on top of a microtiter plate (15), as it would occur during conventional use of the device according to the invention, for example when the device is part of a real-time thermocycler. The heated plate (1) is with its lower side (1b) in direct contact with the microtiter plate (15). The heated plate is formed with a recessed portion (14), in which the there are 96 regions (2) which are translucent in the optical spectral region. In the present embodiment said 96 regions are formed as openings (2) which pass through the entire thickness of the heated plate (1). The heated plate (1) has a border, also called bar (6). In the present embodiment a side wall (3) draws down from the border (6) in order to enclose and surround the frame of the microtiter plate (15). In the present embodiment, the border, bar respectively (6) have no extension over the recessed portion (14). A heating element (10), which in the present embodiment is a resistive foil with holes, is glued to the upper side of the heated plate (1a), in particular to the recessed portion (14) in such a way, that it does not cover or block the openings (2) of the heated plate (1). In the present embodiment the transparent element (4) is a glass plate which rests on the border, respectively bar (6) of the heated plate (1). In the present embodiment the transparent element is glued to the border, respectively bar (6) of the heated plate. Topmost of the device is the means for thermal insulation (5) which encloses all inner components of the device according to the invention. The means for thermal insulation (5) is formed as a solid frame comprising a bottom plate (5a) from which four walls draw downwards (5b, c, d, e)). The four walls are slightly thinner (ca. 1-2 mm) than the bottom plate (2-4 mm). The four walls (5-b-e) are designed to have at least a length reaching down to the cover of the vessels, in the present embodiment to the covers of the microtiter plate. Thus the means for thermal insulation (5) encloses and covers the entire assembly of all inner components of the device according to the invention, and if desired also part or the entirety of the vessels below the device according to the invention. The bottom plate (5a) comprises a multitude of optical, radiation-permeable openings (9), of which there are in the present embodiment 96. The means for thermal insulation (5) does not touch the transparent element (4), but there is an air cushion between those the components. Thus the means for thermal insulation (5) is not fastened to the transparent element (4), instead it is fastened with screws (12) to the heated plate.

FIG. 9: Shown is a full section view of a third embodiment (see also FIG. 8) of the device according to the invention, i.e. the embodiment with an air cushion (17) filling the cavity of the recessed portion (14) of the heated plate (1). The right side of present figure is boxed and enlarged details are shown in FIG. 10. Not explicitly shown in the present figure are any vessels below the heated plate (1). The solid parts of the heated plate (1) are shown shaded, and the openings (2) are non-shaded. The glass plate (4) is shown hatched. The air cushion (11) between means for thermal insulation (5) and glass can be seen.

FIG. 10: Shown is a detailed view of the boxed area of FIG. 9. Visible are the heated plate (1) with lower (1b) and upper side (1a), comprising holes (2) passing through the entire thickness of the heated plate, the heating element (10) indicated by a thick black line on top of the upper side of the heated plate (1a). An air cushion (17) forms in the cavity between recessed portion (14) of the heated plate (1) and transparent element (4). The glass plate (4) can be seen as resting on the border, respectively bar (6) of the heated plate. The air cushion (11) between the means for thermal insulation (5) and transparent element (4) can be seen. Topmost is the means for insulation (5) with its openings (9). All openings (2, 16, 9) passing through the entire device form together a shouldered hole.

FIG. 11: Free view of a fourth embodiment of the device of according to the invention. The device is shown cut open in order to illustrate all components of said device. Said fourth embodiment is characterized through is heated plate without a recessed portion From the border (6) of said heated plate a wall (3) draws down which surrounds the frame of the microtiter plate. The device is shown arranged on top of a microtiter plate (15), as it would occur during conventional use of the device according to the invention, for example when the device is part of a real-time thermocycler. The heated plate (1) is with its lower side (1b) in direct contact with the microtiter plate (15). The heated plate is formed as a solid plate with 96 regions (2) which are translucent in the optical spectral region. In the present embodiment said 96 regions are formed as openings (2) which pass through the entire thickness of the heated plate (1). The heated plate (1) has a border, also called bar (6) without optical openings. In the present embodiment a side wall (3) draws down from the border (6) in order to enclose and surround the frame of the microtiter plate (15). A heating element (10), which in the present embodiment is a resistive foil with holes, is glued to the upper side of the heated plate (1a) in such a way, that it does not cover or block the openings (2) of the heated plate (1). In the present embodiment the transparent element (4) is a glass plate which rests on the entire heated plate (1), except for small part of the border (6) of the heated plate. In the present embodiment the transparent element is glued to the heated plate. Topmost of the device is the means for thermal insulation (5) which encloses all inner components of the device according to the invention. The means for thermal insulation (5) is formed as a solid frame comprising a bottom plate (5a) from which four walls draw downwards (5b, c, d, e)). The four walls are slightly thinner (ca. 1-2 mm) than the bottom plate (2-4 mm) The four walls (5-b-e) are designed to have at least a length reaching down to the cover of the vessels, in the present embodiment to the covers of the microtiter plate. Thus the means for thermal insulation (5) encloses and covers the entire assembly of all inner components of the device according to the invention, and if desired also part or the entirety of the vessels below the device according to the invention. The bottom plate (5a) comprises a multitude of optical, radiation-permeable openings (9), of which there are in the present embodiment 96. The means for thermal insulation (5) does not touch the transparent element (4), but there is an air cushion between those the components. Thus the means for thermal insulation (5) is not fastened to the transparent element (4), instead it is fastened with screws (12) to the heated plate.

FIG. 12: Shown is a full section view of a fourth embodiment (see also FIG. 11) of the device according to the invention, i.e. the embodiment wherein the heated plate (1) is a solid plate without recessed portion. The right side of present figure is boxed and enlarged details are shown in FIG. 13. Not explicitly shown in the present figure are any vessels below the heated plate (1). The solid parts of the heated plate (1) are shown shaded, and the openings (2) are non-shaded. The glass plate (4) is shown hatched. In this embodiment the glass plate is fastened via an elastomer insert (8). The air cushion (11) between means for thermal insulation (5) and glass can be seen.

FIG. 13: Shown is a detailed view of the boxed area of FIG. 12. Visible are the heated plate (1) with lower (1b) and upper side (1a), comprising holes (2) passing through the entire thickness of the heated plate, the heating element (10) indicated by a thick black line on top of the upper side of the heated plate (1a). The glass plate (4) can be seen as lying on the heated plate. In this embodiment the glass plate is fastened via an elastomer insert (8). The air cushion (11) between the means for thermal insulation (5) and transparent element (4) can be seen. Topmost is the means for insulation (5) with its openings (9). All openings (2, 16, 9) passing through the entire device form together a shouldered hole.

FIG. 14: Free view of a fifth embodiment of the device of according to the invention. The device is shown cut open in order to illustrate all components of said device. Said fifth embodiment is characterized through is heated plate without a recessed portion From the border (6) of said heated plate. The device is shown arranged on top of a microtiter plate (15), as it would occur during conventional use of the device according to the invention, for example when the device is part of a real-time thermocycler. The heated plate (1) is with its lower side (1b) in direct contact with the microtiter plate (15). The heated plate is formed as a solid plate with 96 regions (2) which are translucent in the optical spectral region. In the present embodiment said 96 regions are formed as openings (2) which pass through the entire thickness of the heated plate (1). The heated plate (1) has a border, also called bar (6) without optical openings. A heating element (10), which in the present embodiment is a resistive foil with holes, is glued to the upper side of the heated plate (1a) in such a way, that it does not cover or block the openings (2) of the heated plate (1). In the present embodiment the transparent element (4) is a glass plate which rests on the entire heated plate (1), except for small part of the border (6) of the heated plate. In the present embodiment the transparent element is glued to the heated plate. Topmost of the device is the means for thermal insulation (5) which encloses all inner components of the device according to the invention. The means for thermal insulation (5) is formed as a solid frame comprising a bottom plate (5a) from which four walls draw downwards (5b, c, d, e)). The four walls are slightly thinner (ca. 1-2 mm) than the bottom plate (2-4 mm). The four walls (5-b-e) are designed to have at least a length reaching down to the cover of the vessels, in the present embodiment to the covers of the microtiter plate. Thus the means for thermal insulation (5) encloses and covers the entire assembly of all inner components of the device according to the invention, and if desired also part or the entirety of the vessels below the device according to the invention. The bottom plate (5a) comprises a multitude of optical, radiation-permeable openings (9), of which there are in the present embodiment 96. The means for thermal insulation (5) does not touch the transparent element (4), but there is an air cushion between those the components. Thus the means for thermal insulation (5) is not fastened to the transparent element (4), instead it is fastened with screws (12) to the heated plate. Thus the means for thermal insulation (5) does not touch the transparent element (4) and an air cushion forms in between.

FIG. 15: Shown is a full section view of a fifth embodiment (see also FIG. 14) of the device according to the invention, i.e. the embodiment wherein the heated plate (1) is a solid plate without recessed portion. The right side of present figure is boxed and enlarged details are shown in FIG. 16. Not explicitly shown in the present figure are any vessels below the heated plate (1). The solid parts of the heated plate (1) are shown shaded, and the openings (2) are non-shaded. The glass plate (4) is shown hatched. The air cushion (11) between means for thermal insulation (5) and glass can be seen.

FIG. 16: Shown is a detailed view of the boxed area of FIG. 15. Visible are the heated plate (1) with lower (1b) and upper side (1a), comprising holes (2) passing through the entire thickness of the heated plate, the heating element (10) indicated by a thick black line on top of the upper side of the heated plate (1a). The glass plate (4) can be seen as on the heated plate. The air cushion (11) between the means for thermal insulation (5) and transparent element (4) can be seen. Topmost is the means for insulation (5) with its openings (9). All openings (2, 16, 9) passing through the entire device form together a shouldered hole.

### USED DEFINITIONS

In the following, at first some of the used terms are defined and explained.

A “reaction vessel” is any vessel that is used in a laboratory and in which biochemical or chemical reactions are carried out, independent from its material. The reaction vessel can consist of a single vessel or a composite of a multitude of vessels. The reaction vessel can be designed with or without cover. If it is designed without directly connected cover, the vessel can be covered in another manner. Alternative closure forms are un-connected overlieable covers, foils, films, mats and the like. In particular, reaction vessels in the meaning of the present invention are PCR plates and individual PCR vessels.

The term “direct” and “indirect” are used in connection with the heated plate of the device according to the invention. “Direct” means in this context that a heating element is directly at, on, under or within the heated plate itself “Indirect” means in this context that a heating element is not directly at, on, under or within the heated plate itself.

The terms “upper side” and “lower side” are used in connection with the heated plate of the device according to the invention. These terms relate to the orientation of the device with respect to the covers of the reaction vessels which are to be heated by means of the device. The “lower side” is oriented towards the covers, and, in particular, can also overlie the covers. The “upper side” is not oriented to the covers of the reaction vessels, but into the interior of the device. In other words, the “upper side” points to the means of thermal insulation, which delimits the device upwards.

The term “recessed portion” is used in connection with the heated plate. This concerns a recess within the plate, which can be realized in different ways, e.g. by means of material abrasion or also by increasing the side portions.

The term “translucent in the optical spectral region” describes the wavelength region of from 150 nm to 1,200 nm.

The term “transparent” describes the characteristics to be translucent for electromagnetic waves in its entirety and/or for selective regions of the electromagnetic spectrum Thus, this term comprises both the property “transparent” and “translucent”.

The terms “cover” respectively “to cover” are used in the connection with the function of the transparent element of the device according to the invention. The two terms comprise both a direct covering, that is the transparent element directly overlies the region/regions, which are transparent in the optical spectral region; and also an indirect covering, that is the transparent element does not directly overlie the region/regions, which are translucent in the optical spectral region, so that there is still an air space, which may also be filled out by another component.

The term “detachably fastened” and “detachable fastening” describe a fixation, which indeed is stabile but which also can be opened without thereby destroying the involved fastening means. Thus, an opened “detachable fastening” can be re-locked.

The terms “permanently fastened” and “permanent fastening” describe a fixation which can not be non-destructively opened.

The term “heat-resistant” describes the characteristics to survive temperatures from 90° C. to 110° C., preferably from 95° C. to 105° C. and particularly preferred from 96° C. to 100° C. unchanged, i.e. to be inherently stable at these temperatures.

The term “means for thermal insulation” describes in the context of the present invention an article, which absorbs heat and distributes said heat in a manner that no overheating or burning results.

The term “thermal conductor” describes an article, which is characterized by a high thermal conductivity respectively a low thermal resistance.

The terms “plastics” and “polymer” are used synonymously.

### DETAILED DESCRIPTION OF THE INVENTION

The device according to the invention for heating of covers of reaction vessels is part of laboratory equipments. The device according to the invention e.g. can be part of a fluorometer, which is used in order to analyse thermal-dependent biochemical reactions. In particular, such a device is used in thermocyclers, real-time thermocyclers, microtiter plate readers, photometers, spectrometers, microarray readers or a combination of any one of said devices with another one of said devices. The device according to the invention comprises heat-resistant components. In particular, heat-resistant components are preferred which do not degas. This problem is in particular recognized for components, which are made of plastics and/or which are coated with plastics.

The device according to the invention comprises a directly and/or indirectly heated plate having at least a region which is translucent in the optical spectral region. Preferably, the heated plate has a multitude of regions, which are translucent in the optical spectral region, in particular 96, 384 or 1236 translucent regions. The plate can be directly heated e.g. via a resistive element such as a heating foil, a heating cartridge or a conductive coating. The conductive coating has to be selected from a group of substances, which are characterized by a high heat conductance constant λ, that is a λ being higher or equal to 200. In particular suitable are coatings consisting of carbon nanotubes, diamond, silver, copper, gold and/or aluminium or a mixture of two or more of these substances. Likewise suitable coatings are such ones, which comprise one or more of the aforementioned substances besides one or more several further substances; in particular oxides of the above mentioned metals and alloys are suitable. By application of different coatings onto different regions of the plate, it is possible to create differently heated regions of the plate. Different coatings in the meaning of the present invention are coatings from different compositions, however also coatings of the same composition, which are applied in different thicknesses in different regions of the plate. In order to coat the heated plate in at least two regions in different thicknesses or with at least two different coatings has the advantage that in this way a more precise possibility for controlling of the temperature of the plate is possible. So, it is possible to heat individual regions more strongly or more weakly. The plate can also be heated by means of one ore several Peltier elements. In particular also the use of Peltier elements is possible, which have a boring. The use of a multitude of particularly small Peltier elements, the so-called micro-Peltier elements, which are characterized by their size within the millimetre range, is likewise possible. Thereby the micro-Peltier elements are at their longest part between 0.5 and 3 mm, preferably between 0.8 and 2 mm and particularly preferred between 1 and 1.5 mm. At their highest respectively thickest part, the micro-Peltier elements are between 0.05 mm and 1.5 mm, preferably 0.1 mm and 1 mm and particularly preferred between 0.45 and 0.90 mm high respectively thick. The one or the several Peltier elements are thereby arranged in a manner that they do not cover the regions of the heated plate, which are translucent in the optical spectral range. The use of one or more Peltier elements has the advantage that the plate—without a further element—also can be cooled via one or more Peltier elements. This is a considerable improvement of the work safety, since now it is possible to cool down the cover in a controlled manner before the laboratory equipment comprising the heating device is opened.

Furthermore, the plate is also heatable by means of a local electromagnetic alternating field. This has the advantage that the triggered temperatures can be set very accurately and can be accurately switched off. When selecting the material of the plate, it has to be considered, that the material can be magnetized.

Also, the heated plate can be capacitively heated. For example, the heated plate can be designed such that it comprises two regions, which function as plates of a parallel-plate capacitor, wherein a dielectric is between said two regions. The dielectric can be selected from air, polyethylene, polytetrafluoroethylene (PTFE), ceramics (e.g. steatite, aluminium oxide) and mica. A capacitively heated plate has the advantage that it allows for a very homogeneous heating. Also, the plate can be heated via a liquid. The plate is then designed such that it has channels in which the liquid can circulate. The liquid itself is tempered in order to achieve a tempering of the plate.

For example, the plate can be indirectly heated via infrared radiation. Thereby, the infrared radiation can be directly directed to the plate but also can be directed via a mirror to the plate. Alternatively, the plate can be indirectly heated by means of hot air.

The heated plate transfers the heat to the covers of the reaction vessels via convection and/or conduction. Thereby, the heated plate is in direct contact with the covers of the reaction vessels, or a mediating medium is present between the heated plate and the covers. As medium not the sealing foil is meant, which can be arranged on the reaction vessels. The medium rather is a second transparent plate or a transparent container, which is filled with gas, liquid and/or a viscoelastic fluid (in particular a gel). Also the gas, the liquid or the viscoelastic fluid are transparent. Preferably, the viscoelastic fluid is a gel. The container preferably is a bag, which is made from a heat-resistant material, preferably polymers or silicon elastomers. In order to ensure a particular stability and heat resistance of the bag, the heat-resistant material may have a layered laminate-like structure. In a particular embodiment, the bag has form-imparting elements in such regions, which are not in the optical path between cover of the reaction vessel and the at least one region, which is transparent in the optical spectral region of the heated plate. Examples for form-imparting elements are worked-in reinforcements, e.g. ribs. The heated plate has an upper side which is designed with or without a recessed portion, and a lower side. The upper side of the heated device points to the interior of the heated device and is not in direct contact with structures, which are outside of the device. The lower side points in direction of the cover of the reaction vessels and is either in direct or indirect contact with the covers of the vessels. For example, it overlies the covers of the vessels or there is additionally a mediating element below the heated plate, e.g. a transparent plate or an elastic transparent mat or foil.

For the upper side of the heated plate, two alternative embodiments are possible. In the first embodiment, the heated plate is designed without recessed portion. Thus, the upper side of the heated plate forms a horizontal plane. This is with regard to production particularly preferable since such a plate can be simply manufactured and can be very simply assembled with the remaining components of the device.

In the alternative embodiment, the heated plate has on the upper side at least one recessed portion. Particularly preferred is a heated plate in which the recess is designed such that nearly the whole central region of the upper side is cut-out so that only a border respectively a bar—these terms are synonymously used—remain having a width of 0.3 cm to 1.5 cm preferably 0.5 cm to 1.3 cm and in particular preferred from 0.8 cm to 1 cm. The form of the central cut-out region of the upper plate depends on the arrangement of the laboratory vessels to be heated. Preferably, the recessed portion has the rectangular form of a microtiter plate that is it has the dimensions of the base area of a commercial microtiter plate. In particular, the cut-out has a length of between 10 cm and 15 cm, preferably between 11 cm and 14 cm and particularly preferred between 12 and 13 cm. The cut-out has a width of 6 cm to 11 cm, preferably from 7 cm to 10 cm and particularly preferred from 8 cm to 9 cm. The cut-out has a depth of 1 mm to 10 mm preferably 2 mm to 8 mm and particularly preferred from 3 mm to 5 mm. Due to the at least one recessed portion, an extensive region of the upper side of the plate is positioned more deeply than the surrounding bar respectively border of the plate. In the at least one recessed portion, the plate is thinner than the remaining region of the heated plate. This is advantageous since thus the plate region, which is in direct proximity to the covers of the laboratory vessels, can be heated faster, that is, the triggered end temperature can be set faster. A further advantage is the material saving and thus cost savings in the manufacture of the heated plate.

Another advantage results from the interaction of the heated plate, which has a recessed portion on the upper side, with the remaining components of the device for heating, in particular with the transparent element. The transparent element is detachably or permanently fastened on the border respectively the bar of the heated plate having a recessed portion. Thus, between the transparent element and the heated plate a cavity is formed, which is filled with air. The air in this cavity is also heated and thus a warm air cushion is formed, which contributes to the homogeneous tempering of the heated plate and the covers of the reaction vessels and the transparent element. Temperature differences are not desired, since otherwise condensation in the covers of the vessels or on the transparent element would occur.

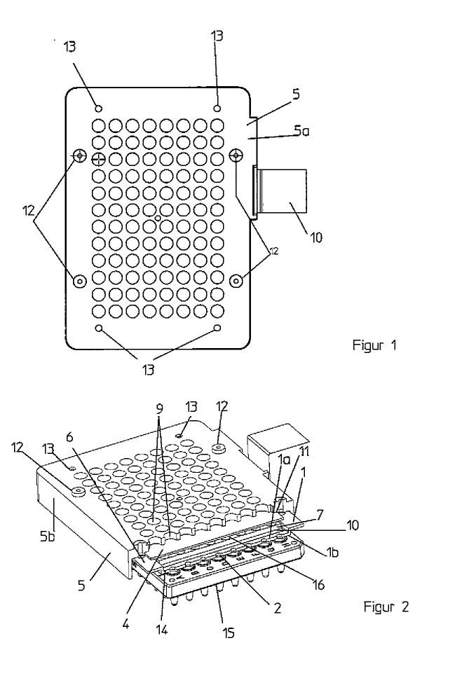

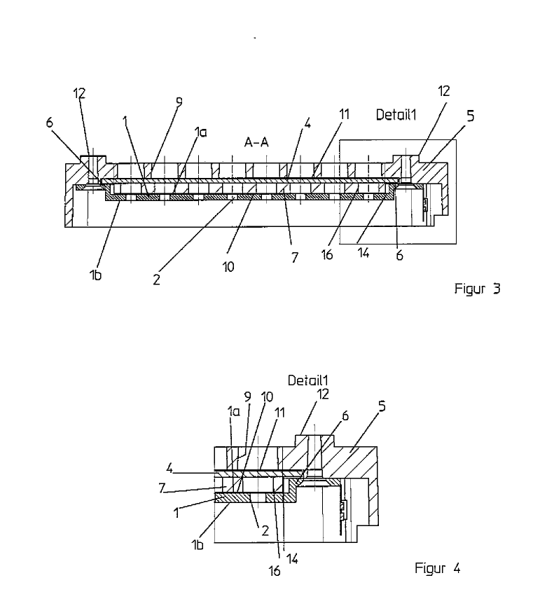

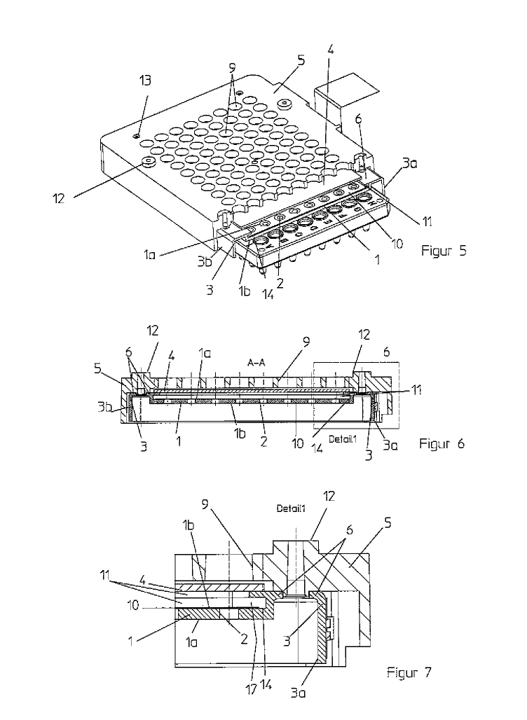

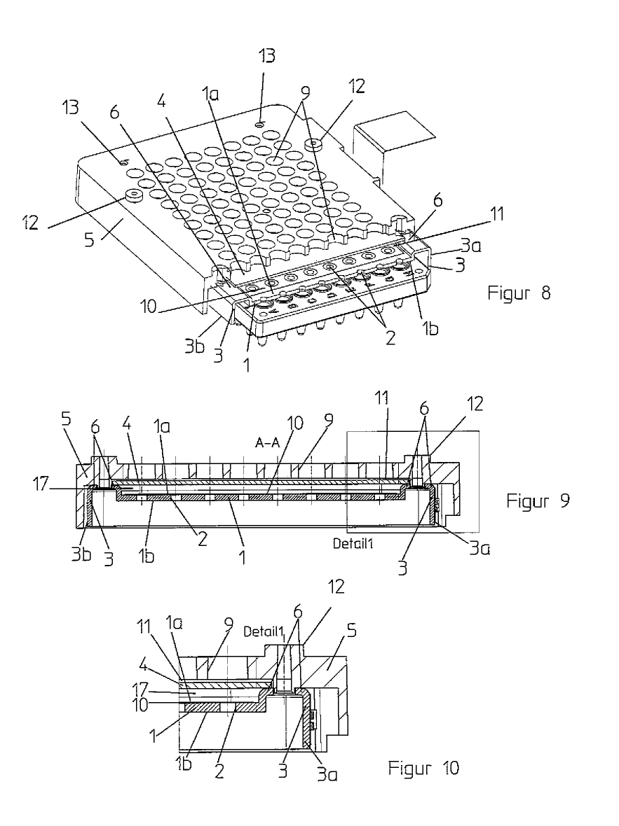

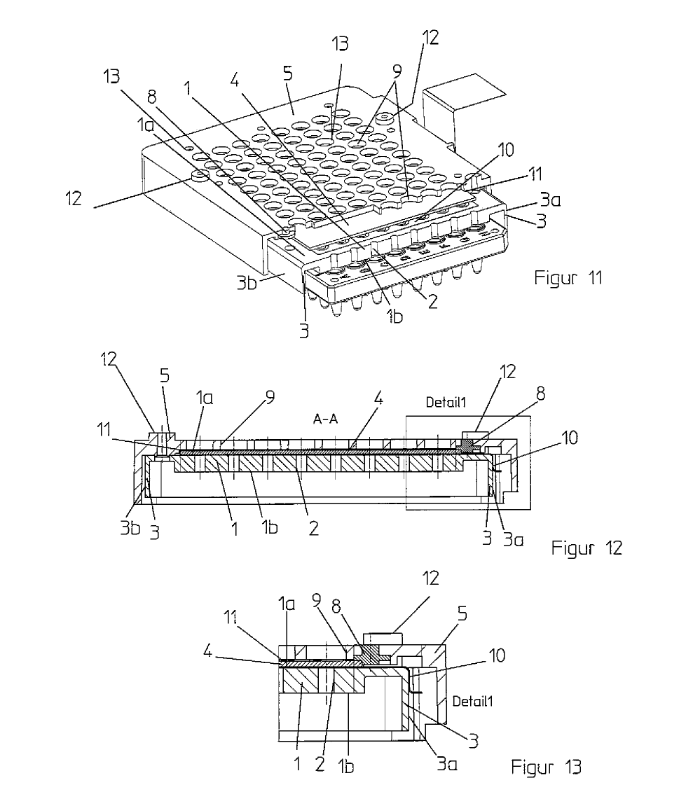

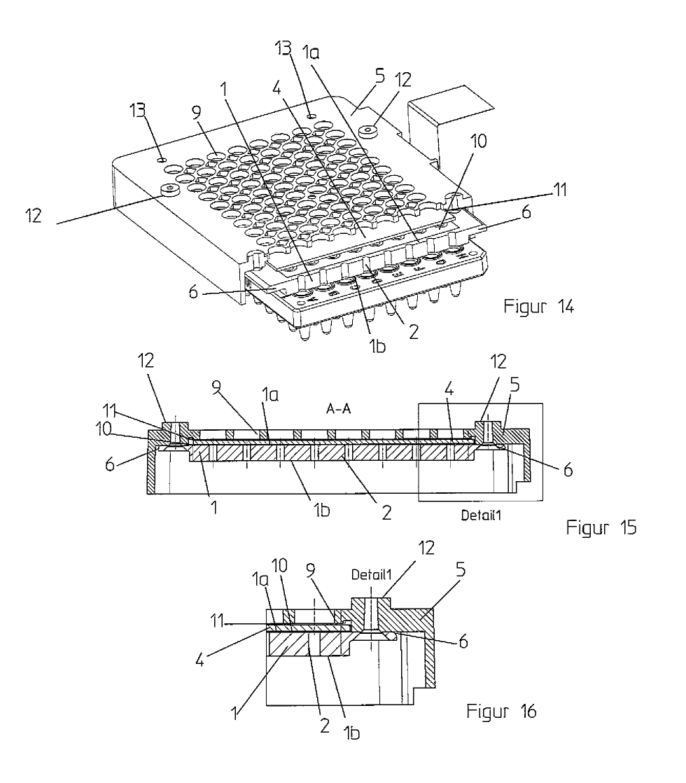

In an alternative embodiment, the cavity between the heated plate having the recessed portion on the upper side and the transparent element, is filled with a thermal conductor. The thermal conductor serves for the heat conductance from the heated plate to the transparent element. Preferably, the thermal conductor consists of another material as the heated plate. This has the advantage that for the thermal conductor a very light material can be selected so that all in all the weight of the device for heating is reduced. For example, the plate can be made from aluminium and the thermal conductor from foamed aluminium or a foamed aluminium alloy. The thermal conductor has, as can be seen in FIGS. 1, 2 and 3 also a multitude of optical, radiation permeable openings aligned with the at least one region translucent in the optical spectral region (2) of the heated plate.

The heated plate of the device according to the invention has at least one region, which is translucent in the optical spectral region. This region is selected such that it is permeable for electromagnetic radiation between 200 nm and 1,100 nm, preferably between 300 and 900 nm and in particular preferred between 350 and 800 nm. The transparent region is selected from the group of cylindrical openings, which run through the plate in its entire thickness; openings, which taper towards the upper side of the plate, which run through the plate in its entire thickness; cylindrical openings, which run through the plate in its entire thickness, wherein in said cylindrical openings a transparent body is inserted; openings, which taper towards the upper side of the plate, which run through the plate in its entire thickness, wherein in said tapering opening a transparent body is inserted. The transparent body is a lens, such as a liquid lens, intelligent lens or a Frenell lens. Alternatively, said transparent body is not a lens but a transparent body, which is adapted to the form of the opening, e.g. a cylinder or a graded cylinder, which does not serve the purpose of optical imaging. In particular openings being filled with a transparent body, have the advantage that via the selection of the transparent body the strength and quality of the excitatory signal and the outgoing signal can be influenced.

At all four sides, the heated plate has a wall which is drawn downwards. The length of the wall is determined by the height of the covers of the reaction vessels to be heated. Preferably, the wall has a height between 0.5 cm and 3 cm, preferably between 1 cm and 2.5 cm and particularly preferred between 1 cm and 1.5 cm. If the upper side of the heated plate is designed with a recessed portion, the wall being drawn down-wards emerges from the outer edge of the border respectively the bar. —

Furthermore, the device according to the invention comprises at least one transparent element selected from the group consisting of foils, plates and cuboids. This at least one transparent element serves for the covering of the at least one regions being translucent in the optical spectral region. Thus, the transparent element is the first barrier against the upwards discharge of heat and hot vapour. In conventional use of the device according to the invention, the optical elements are above the device according to the invention. These are highly sensitive and susceptible to faults. In particular, it was recognized that depending on the condition of the covers of the reaction vessels to be heated, vapours can be formed, which condense on the highly sensitive lens system of the optics, respectively are deposited. Thus, an advantage of the device according to the invention is the prevention of formation of such deposits by means of the barrier function of the transparent element. Thereby, the transparent element overlies the upper side of the heated plate, however, wherein it does not lie within the recessed portion of the upper side of the heated plate. The transparent element is detachably or permanently fastened on the heated plate. In a heated plate having a recessed portion on the upper side, the transparent element is detachably or permanently fastened on the border respectively the bar. For a detachable fastening, the fastening means is selected from the group of clamps, cramps, elastomer naps, hook- and loop fastener, magnetic locks, detachable snap fits, and electrostatic connections. Preferably, the transparent element is clamped, is fastened via an elastomer nap or is detachably fastened via a snap fit. In order to permit the clamping, then at least two pivots are inserted on the border of the upper side of the plate, which serve as a fixed bearing. Also possible is a combination of fixed bearing and elastomer naps. Thereby preferred is the combination of a pivot having from 2 to 8 elastomer naps, preferably of a pivot and 3 to 6 elastomer naps and particularly preferred of a pivot and 4 elastomer naps. This type of detachable mounting has the advantage that the transparent element is a floating element, and so the extensions and movements caused by heat are balanced.

In a permanent fastening, the fastening type is selected from the group of welding, gluing, riveting, soldering, in particularly soldering using indium, and non-detachable snap-fits. The detachable fastening has the advantage that the transparent element can be dismantled from the device according to the invention for cleaning and maintenance purposes, and, if necessary, can be exchanged.

The at least one transparent element is selected from the group of transparent foils, plates and cuboids, which are all formed from a heat-resistant material. Is the transparent element a foil, then said foil consists of a thermoplastic plastics selected from the group of polycarbonate (PC)-, polyethyleneterephthalate (PET)-, perfluoroalkoxy (PFA)-, polysulfone (PSU)-, polyethersulfone (PES)-, polyphenylenesulfone (PPSU)-, polyetherimide (PEI), cyclo-olefin polymer (COP), polytetrafluoroethylene (PTFE), and cyclo-olefin copolymer (COC), or from a silicon elastomer. Particularly preferred is a foil made from PTFE. PTFE, which is also sold under the name Teflon, is a thermoplastic having certain thermosetting properties. Teflon particularly is characterized by its low index of refraction, which is approximately 1.38, and by its property to be transparent also for infrared radiation in the far region. A foil made from Teflon further has the advantage that it is extremely dirt resistant, since, due to the extremely low surface tension, nothing adheres. A transparent element made from foil is characterized by its flexibility. This has the advantage that shear stresses between heated plate and the foil can be well balanced. The foil is characterized by a thickness of 25 μm to 250 μm preferably 50 μm to 150 μm and in particular preferred from 65 μm to 100 μm.

If the transparent element is a plate, then its material is selected from the group of transparent glass, transparent plastics, transparent artificial sapphire and transparent mineral. In order to impart further characteristics, in a particular embodiment, the surface of the plate, independent from which of the above mentioned material it is formed, is coated in order to prevent formation of reflexes. Further properties, which may be adjusted by means of the coatings, are the non-fluorescence, the scratch resistance and the resistance against dirt. In order to achieve an extreme scratch resistance, the surfaces may be e.g. coated with diamond. In one embodiment of the plate, it consists of a transparent and heat-resistant plastic. Preferably, said plastics is selected from the group of polycarbonate (PC)-, polyethyleneterephthalate (PET)-, perfluoroalkoxy (PFA)-, polysulfone (PSU)-, polyethersulfone (PES)-, polyphenylenesulfone (PPSU)-, polyetherimide (PET), cyclo-olefin polymer (COP), polytetrafluoroethylene (PTFE), and cyclo-olefin copolymer (COC). Furthermore, the plate can consist of artificial sapphire. This has the advantage that such a plate is scratch-resistant and has very high heat conductivity. The high scratch resistance facilitates the cleaning of such a plate. The plate may also consist of a transparent mineral such as quartz, mica or artificial mica. In particular mica and artificial mica are preferred, since these minerals have an extremely high melting point, and therefore are extremely heat-resistant. Thin slices of said minerals are transparent. A plate is characterized by a thickness of 250 μm to 15 mm, preferably 500 μm to 10 mm and particularly preferred from 1 mm to 5 mm. If the transparent element is a cuboid, then its material is selected from the group of transparent glass, transparent plastics, transparent artificial sapphire and transparent mineral. In order to impart additional properties, in a particular embodiment, the surfaces of said cuboid, independently from which of the above mentioned materials the cuboid is formed, are coated in order to prevent formation of reflexes (anti-reflex coating). Further properties, which can be set via the coatings, are the non-fluorescence, the scratch-resistance and the dirt resistance. In order to achieve an extreme scratch-resistance, all or selected surfaces of the cuboid may be e.g. coated with diamond. In a particular embodiment of the cuboid, the cuboid is made of a transparent and heat-resistant plastic. Preferably, said plastics is selected from a group of polycarbonate (PC)-, polyethyleneterephthalate (PET)-, perfluoroalkoxy (PFA)-, polysulfone (PSU)-, polyethersulfone (PES)-, polyphenylenesulfone (PPSU)-, polyetherimide (PEI), cyclo-olefin polymer (COP), polytetrafluoroethylene (PTFE), and cyclo-olefin copolymer (COC). The cuboid can further consist of an artificial sapphire. This has the advantage that such a cuboid is scratch-resistant and has a very high thermal conductivity. The high scratch resistance facilitates the cleaning of such a cuboid. The cuboid can also be made from a transparent mineral such as quartz. A cuboid is characterized by a thickness of 15 mm to 300 mm preferably 50 mm to 200 mm and particularly preferred from 100 mm to 150 mm.

Any transparent element additionally can have a thermal conductive coating. Particularly suitable are coatings consisting of carbon nanotubes, diamond, silver, copper, gold, and/or aluminium or a mixture of two or more of these substances. Likewise suitable coatings are such ones, which comprise one or more of the before mentioned substances besides one or more further substances; in particular suitable are oxides of the above mentioned metals and alloys.

The device according to the invention comprises as further component a means for the thermal insulation. Said means serves for avoiding overheating and burning. It increases quite essentially the safety of the device according to the invention, since it encloses the heated part of the device, the heated plate and the surrounding heated component, the transparent element. In the design of the means for thermal insulation, it has to be considered that said means also has at least one region that is translucent at least in the optical spectral range, which is positioned in such a manner that it rests over the at least one portion of the heated plate that is translucent the optical spectral region. This is intended to ensure that there is an optical communication through the heated device between optical elements, which are arranged in a conventional use above the device according to the invention, and the reaction vessels respectively the content thereof, which are arranged below the device according to the invention in the conventional use. The means for the thermal insulation e.g. can be designed as frame, which comprises a plate with borings, wherein side walls are drawn downwards from the borders of the plate. The side walls are dimensioned such that they enclose the whole device at the sides. This has the advantage that the user or the technician has no direct contact with heated or strongly heated components of the device, and so the risk of burns is reduced.

This completes the description of the preferred and alternate embodiments of the invention. Those skilled in the art may recognize other equivalents to the specific embodiment described herein which equivalents are intended to be encompassed by the claims attached hereto.

What is claimed is:

1. A device for the heating of covers of reaction vessels, which comprises the following components:
(a) a directly and/or indirectly heated plate (1), having an upper side (1a), which is at least designed with one or without recessed portion, and a lower side (1b), wherein the heated plate has at least one portion (2), which is translucent in the optical spectral region,
(b) at least one transparent element (4) selected from the group of foils, plates and cuboids for covering the at least one of portion (2) of the heated plate which is translucent in the optical spectral region, wherein the at least one transparent element is not arranged in the recessed portion of the heated plate; and
(c) a member for thermal insulation (5), wherein said member has at least one region, which is translucent in the optical spectral region, and which encloses/covers the components defined in (a) and (b).

2. The device of claim 1, wherein the heated plate has at all four sides a wall (3) (3a, b), which is drawn downwards.

3. The device of claim 1, wherein the heated plate has a recessed portion, and the wall (3a, b, c, d), which is drawn downwards at all four sides, emerges from a bar (6), which surrounds the whole plate.

4. The device of claim 3, in which the transparent element (4) is detachably or permanently fastened on the bar (6).

5. The device of claim 3, wherein at least one thermal conductor (7) is in the recessed portion of the heated plate (1), without blocking the at least one portion (2), which is translucent in the optical spectral region.

6. The device of claim 5, in which the transparent element (4) is detachably or permanently fastened on the thermal conductor (7).

7. The device of claim 1, wherein the heated plate (1) has no recessed portion and the wall (3, 3a, 3b), which is drawn downwards at all four sides, emerges from a bar (6), which surrounds the whole plate.

8. The device of claim 7, in which the transparent element (4) is detachably or permanently fastened on the heated plate (1).

9. The device of claim 4, in which the transparent element is detachably fastened via at least one elastomer insert (8), preferably via two to ten elastomer inserts, and particularly preferred via two to six elastomer inserts.

10. The device of claim 1, in which the transparent element is a foil selected from the group of the thermoplastic plastics such as polycarbonate (PC)-, polyethyleneterephthalate (PET)-, perfluoroalkoxy (PFA)-, polysulfone (PSU)-, polyethersulfone (PES)-, polyphenylenesulfone (PPSU)-, polyetherimide (PEI)-, cyclo-olefin polymer (COP)-, polytetrafluoroethylene (PTFE)- and cyclo-olefin copolymer (COC) or is a silicon elastomer.

11. The device of claim 1, in which the transparent element is a plate selected from the group of the materials glass, plastics, artificial sapphire and mineral.

12. The device of claim 1, in which the transparent element is a cube selected from the group of the materials glass, plastics, artificial sapphire.

13. The device of claim 1, in which the member for the thermal insulation is designed as frame, which surrounds all the other elements of the device according to the invention.

14. The device of claim 13, in which the frame has a bottom plate having a multitude of optical, radiation-permeable openings (9) and has an edge, which surrounds the whole plate.

15. The device of claim 14, in which the member for the thermal insulation is a heat-insulating material selected from the group of plastics, ceramics, cork and wood.

16. Use of the device of claim 1, in a laboratory device.
